(19) United States
(12) Patent Application Publication
(10) Pub. No.: US 2025/0119280 A1
(43) Pub. Date: Apr. 10, 2025

(54) QUANTUM UNIQUE AUTHENTICATED CHAFF KEY (QUACK)

(71) Applicant: Wells Fargo Bank, N.A., San Francisco, CA (US)

(72) Inventor: Jeffrey J. Stapleton, O'Fallon, MO (US)

(73) Assignee: Wells Fargo Bank, N.A., San Francisco, CA (US)

(21) Appl. No.: 18/377,936

(22) Filed: Oct. 9, 2023

(51) Int. Cl. H04L 9/08; H04L 9/14; H04L 9/32

(52) U.S. Cl. CPC H04L 9/0858; H04L 9/14; H04L 9/3242

(57) ABSTRACT

The arrangements disclosed herein relate to generating, by a first device, an authentication code for each of portions of a first message by running each of the portions of the first message through a cryptographic function with a cryptographic key. The first device generates a plurality of valid chunks, each including one of the plurality of portions of the first message and the corresponding authentication code. The first device generates using a Quantum Random Number Generator (QRNG) a random number for each portion of a second message. The first device generates invalid chunks, each invalid chunk includes one of the portions of the second message and the corresponding random number. The first device sends to the second device chaff including the invalid chunks interleaved with the valid chunks.

### BACKGROUND

Encryption for in-motion or in-flight data is not always practical. For national security reasons, some countries place moderate to severe restrictions and controls on cryptography. Many organizations monitor and decipher its secured connections, such as Transport Layer Security (TLS) visibility. Alternatively, message authentication relies on cleartext messages with cryptographic mechanisms such as Hash-based Message Authentication Code (HMAC) or digital signatures. HMAC relies on symmetric algorithms (e.g., Advanced Encryption Standard (AES)) which are faster than asymmetric algorithms such as Rivest-Shamir-Adleman (RSA), Digital Signature Algorithm (DSA), and Elliptic Curve Digital Signature Algorithm (ECDSA). Some implementations rely on both mechanisms for encryption and authentication. In one example, the sender computes the authentication on the cleartext message, encrypts the message, and sends both items to the receiver, who in reverse order, decrypts the message and verifies the authentication. In another example, the sender computes the authentication on the cleartext message, encrypts the message and the authentication, and sends one item to the receiver, who in reverse order, decrypts the object to recover the message and the authentication, and verifies the authentication.

### SUMMARY

The arrangements disclosed herein relate to systems, methods, non-transitory computer-readable media, and apparatuses for generating, by a first device, a first authentication code for each of a plurality of portions of a first message by running each of the plurality of portions of the first message through a first cryptographic function with a first cryptographic key, generating, by the first device, a plurality of first chunks, each of the plurality of first chunks includes one of the plurality of portions of the first message and the corresponding first authentication code, generating, by the first device, a second authentication code for each of a plurality of portions of a second message by running each of the plurality of portions of the second message through a second cryptographic function with a second cryptographic key, wherein at least one of the first cryptographic key or the second cryptographic key is generated using Quantum Key Distribution (QKD), generating, by the first device, a plurality of second chunks, each of the plurality of second chunks includes one of the plurality of portions of the second message and the corresponding second authentication code, and sending, by the first device to the second device, chaff including the plurality of second chunks interleaved with the plurality of first chunks.

The arrangements disclosed herein relate to systems, methods, non-transitory computer-readable media, and apparatuses for generating, by a first device, an authentication code for each of portions of a first message by running each of the portions of the first message through a cryptographic function with a cryptographic key. The first device generates a plurality of valid chunks, each including one of the plurality of portions of the first message and the corresponding authentication code. The first device generates using a Quantum Random Number Generator (QRNG) a random number for each portion of a second message. The first device generates invalid chunks, each invalid chunk includes one of the portions of the second message and the corresponding random number. The first device sends to the second device chaff including the invalid chunks interleaved with the valid chunks.

These and other features, together with the organization and manner of operation thereof, will become apparent from the following detailed description when taken in conjunction with the accompanying drawings.

### BRIEF DESCRIPTION OF THE DRAWINGS

FIG. 1 is a schematic diagram illustrating an example method for performing authentication, according to various arrangements.

FIG. 2 is a schematic diagram illustrating an example method for performing authentication, according to various arrangements.

FIG. 3 is a schematic diagram illustrating an example chaff according to various arrangements.

FIG. 4 is a schematic diagram illustrating an example chaff according to various arrangements.

FIG. 5 is a schematic block diagram illustrating a QKD method, according to some arrangements.

FIG. 6 is a flowchart diagram illustrating an example method for performing authentication, according to various arrangements.

FIG. 7 is a flowchart diagram illustrating an example method for performing authentication, according to various arrangements.

FIG. 8 illustrates block diagrams of an examples of the first device and the second device, according to some arrangements.

### DETAILED DESCRIPTION

The arrangements disclosed herein relate to systems, apparatuses, methods, and non-transitory computer-readable media for quantum-based cryptographic techniques (e.g., chaffing) for obfuscating data-in-motion using authentication without encryption. In some arrangements, a Quantum Random Number Generator (QRNG) generates an invalid chaff including of a second message with invalid authentication codes that can be separated from a primary valid chaff. In some arrangements, Quantum Key Distribution (QKD) is used to distribute the key used to generate or verify the valid chaff. Chaffing provides message obfuscation using authentication without encryption. The use of QRNG enhances chaffing mechanisms with true random numbers. QKD provides a chaffing mechanism with authentication.

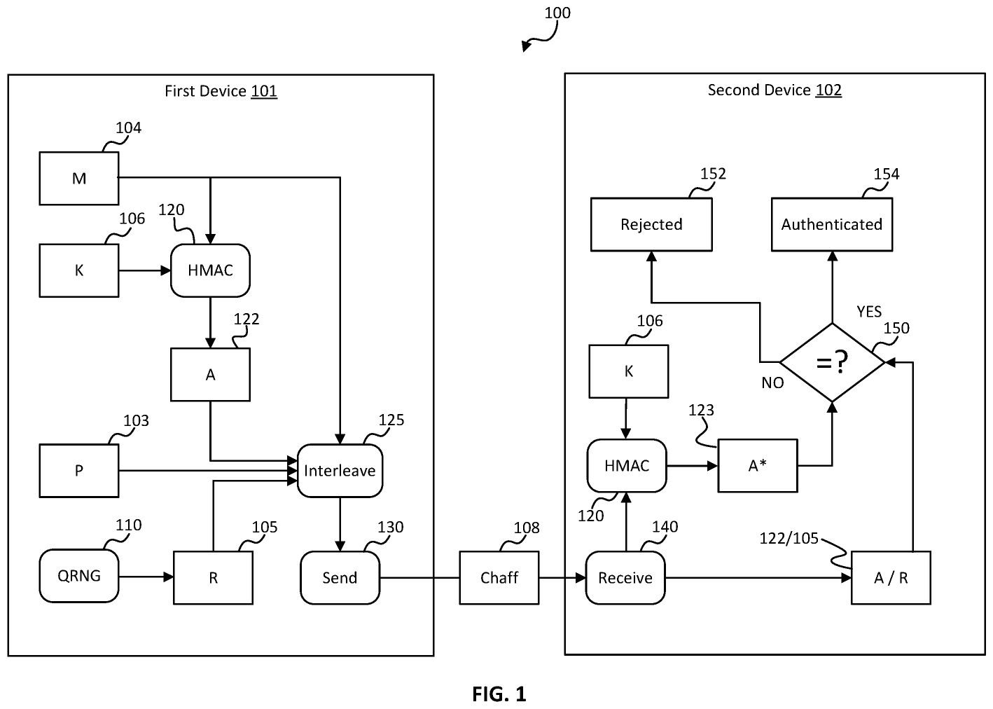

In some arrangements, primary authentication with invalid chaff uses a QRNG to generate invalid message chunks that, without knowledge of the cryptographic key (K), are indistinguishable from valid message chunks. For example, the QRNG can generate invalid authentication codes for invalid message chunks, to be sifted out by the receiver. FIG. 1 is a schematic diagram illustrating an example method 100 for performing authentication, according to various arrangements. The method 100 can be performed using a first device 101 and a second device 102. The first device 101 (e.g., a sender) sends a chaff 108 to the second device 102 (e.g., a receiver).

In some arrangements, the first device 101 divides (e.g., partitions, dissects, and so on) a cleartext message 104 (M) into a plurality of N portions (m₁, m₂, . . . , m_{N}), e.g., M=m₁, m₂, . . . , m_{N}. The first device 101 generates a message authentication code 122 (e.g., A=a₁, a₂, . . . , a_{N}) for each of the N portions. For example, the first device 101 can input each portion of the cleartext message 104 (M) and a cryptographic key 106 (K) into a cryptographic function such as a Hash-based Message Authentication Code (HMAC) 120 to generate the message authentication code 122 (A) for each chunk of the message 104. In some examples, each message authentication code is a check value for a corresponding portion of the message 104.

In some arrangements, the cleartext message 104 described herein can be any type of information. Examples of message 104 can include a Personal Identification Number (PIN), a Primary Account Number (PAN) which is the payment card number (e.g., a credit card number, a debit card number, and the like), a financial account number, a password, social security number, a name, an address, an email address, or any Personally Identifiable Information (PII) or Protected Health Information (PHI). In some examples, the message 104 can be a security object (e.g., a token, a certificate, and the like). In some examples, the message 104 can be a seed for key-generation (e.g., for generating a One-Time-Password (OTP)). The message 104 refers to any information that needs protection during transmission and storage.

The first device 101 can determine valid chunks for the message 104, such as the pairs (m₁, a₁), (m₂, a₂), . . . (m_{N}, a_{N}). That is, each valid chunk is a pair including a portion of the cleartext message 104 and a corresponding message authentication code for that portion. In some examples, the authentication code 122 for each portion of the message 104 can be concatenated or appended to the portion of the message 104, such that the valid chunks can be represented as (m₁, a₁), (m₂, a₂), . . . (m_{N}, a_{N}). In other examples, each authentication code 122 and a corresponding portion of the message 104 for which the authentication code 122 is generated can be combined in another suitable method.

The first device 101 uses the QRNG 110 to generate invalid authentication codes such as the random number 105 (R), e.g., R=r₁, r₂, . . . , r_{N}, for another message 103 (P). In some arrangements, the first device 101 divides (e.g., partitions, dissects, and so on) the message 103 into a plurality of N portions (p₁, p₂, . . . , p_{N}), e.g., P=p₁, p₂, . . . , p_{N} (also referred to as random chunks). The first device 101 uses a random number 105 (R) as an invalid message authentication code (a respective one of r₁, r₂, . . . , r_{N}) for each of the N portions of the message 103. Given that the random number 105 is not generated as a result of running a portion of the message 103 through an HMAC, the random number 105 cannot serve to actually authenticate any portion of the message 103, e.g., the random number 105 is not a check value for a corresponding portion of the message 103. In some examples, the QRNG 110 is a true RNG that provides a random number 105 that is unpredictable.

In some examples, the message 103 can be a valid message that is different from the message 104. In some examples, the message 103 can be a randomized string of alphanumeric values. The first device 101 does not intend for the second device 102 to use the message 103 for any tasks aside from authentication and verification. That is, the message 103 is used for only chaffing for the message 104.

The first device 101 can generate invalid chunks, such as the pairs (p₁, r₁), (p₂, r₂), . . . (p_{N}, r_{N}), for the message 103 using the random numbers 105. That is, each invalid chunk is a pair including a portion of the message 103 and a corresponding invalid message authentication code for that portion. In some examples, a respective random number 105 (e.g., a respective one of r₁, r₂, . . . , r_{N}) for each portion of the message 103 can be concatenated or appended to the portion of the message 103, such that the valid chunks can be represented as (p₁, r₁), (p₂, r₂), . . . (p_{N}, r_{N}). In other examples, a respective random number 105 and a corresponding portion of the message 103 for which the respective random number 105 is generated can be combined in another suitable method.

In some examples, a sufficient number of valid chunks and invalid chunks are needed to obfuscate the message 104 to hide the message 104. For example, for a message that includes a 16-digit PAN within a 32-digit message, there is a 3.125% chance that each digit is valid, which is too high. Sending 128 digits can reduce the probability to 0.7%, although cryptographically that probability remains high.

In some examples, the first device 101 interleaves these invalid chunks with the valid chunks at 125. In some examples, the invalid chunks (p₁, r₁), (p₂, r₂), . . . (p_{N}, r_{N}) and the valid chunks (m₁, a₁), (m₂, a₂), . . . (m_{N}, a_{N}) are interleaved in a random pattern. In some examples, a number (e.g., any number that is 0 or greater than 0) of at least one invalid chunk and/or which one(s) of the invalid chunks included between two adjacent valid chunks in sequence can be random. In some examples, after being interleaved randomly with the invalid chunks, the valid chunks maintain their respective sequence but with none or at least one invalid chunk between two adjacent valid chunks. In some examples, after being interleaved randomly with the invalid chunks, the valid chunks do not maintain their respective sequence, with none or at least one invalid chunk between two adjacent valid chunks. The resulting data structure with the invalid chunks interleaved with the valid chunks is referred to as the chaff 108. The first device 101 sends the chaff 108 that includes the valid chunks interleaved with the invalid chunks to the second device 102, which is a receiver.

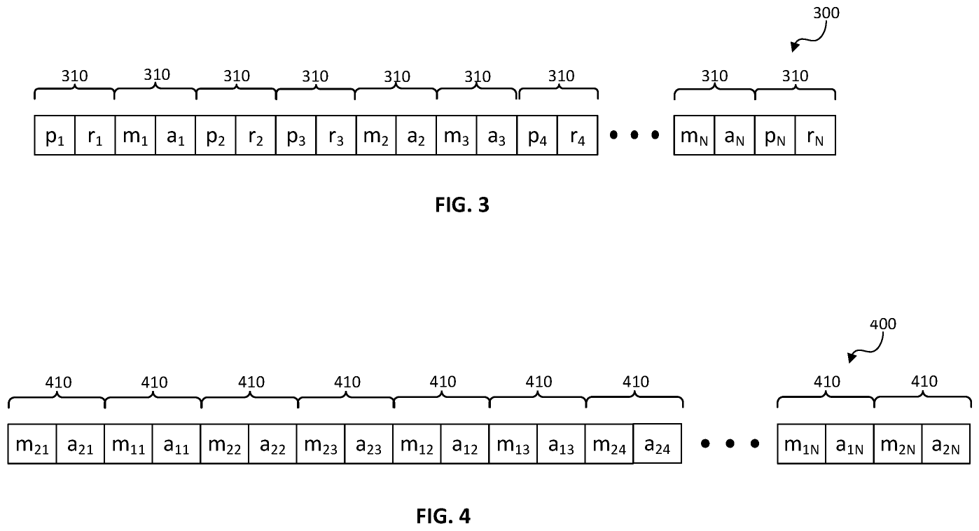

FIG. 3 is a schematic diagram illustrating an example chaff 300 according to various arrangements. The chaff 300 is an example of the chaff 108. The chaff 300 includes chunks 310. Each chunk 310 of the chaff 300 can be an invalid chunk (n, r) or a valid chunk (m, a). In some arrangements, each chunk of the chaff 300 has a data packet size, which is a suitable data size for transmitting a unit of data over a network as a network data packet. That is, the chunks 310 of the chaff 300 have a same size. As shown, the invalid chunks (p₁, r₁), (p₂, r₂), . . . (p_{N}, r_{N}) are interleaved with the valid chunks (m₁, a₁), (m₂, a₂), . . . (m_{N}, a_{N}). In some examples, at least one invalid chunk is immediately between two adjacent valid chunks. In some examples, there is no invalid chunk between two adjacent valid chunks. In some examples, at least one valid chunk is immediately between two adjacent invalid chunks. In some examples, there is no valid chunk between two adjacent invalid chunks. While the invalid chunks are shown to have N elements (e.g., (p₁, r₁), (p₂, r₂), . . . (p_{N}, r_{N})) which is the same as the number of elements for the valid chunks, given that in some examples, the invalid chunks and the valid chunks are interleaved in a random pattern as shown, there can be any number of invalid chunks interleaved with the valid chunks.

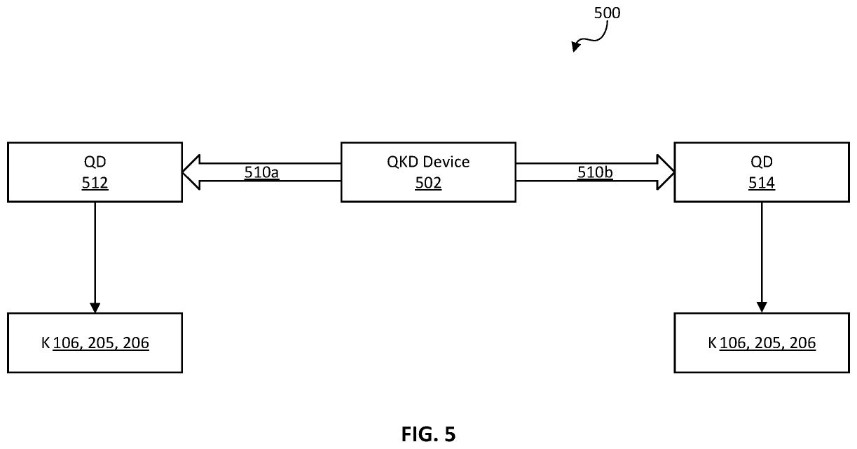

The first device 101 sends the chaff 108 to the second device 102 at 130. The second device 102 receives the chaff 108 at 140 and verifies each chunk (e.g., each chunk 310) of the chaff 108 (e.g., the chaff 300) using the cryptographic key 106 (K). Given that the chaff 108 includes the valid chunks interleaved with the invalid chunks, the valid chunks can be winnowed from the invalid chunks to reassemble the cleartext message 104. In some examples, to verify each chunk of the chaff 108, the second device 102 runs a first portion or a data portion of each chunk (e.g., m or n) through a same cryptographic function (e.g., the HMAC 120) with the same cryptographic key 106 (K) to generate a possible message authentication code A* 123, which is compared at 150 with a second portion or authentication code portion of the chunk, which can be the message authentication code 122 (A) or the random number 105 (R) depending on whether the chunk is a valid or invalid. In some examples, the first device 101 and the second device 102 can establish the symmetric cryptographic key 106 (K) using any suitable key distribution methods, including QKD described with respect to FIG. 5.

In response to determining that the possible message authentication code generated by the second device 102 matches the second portion of the chunk (e.g., A*=A), e.g., 150=YES, then that chunk is authenticated at 154. On the other hand, in response determining that the possible message authentication code generated by the second device 102 fails to match the second portion of the chunk (e.g., A≠A), e.g., 150=NO, then that chunk is reject3ed or fails to be authenticated at 154. In other words, the chunk is determined to be an invalid chunk. Given that the invalid chunks include The message 103, the second portion of an invalid chunk, which is the random number 105, would not match the result of running the first portion of the invalid chunk through the HMAC 120. The second device 102 reassembles the first portions of the valid chunks to recover the original cleartext message 104 (M).

In some examples, the second device 102 discards the invalid chunks. In some examples, the second device 102 can retain the invalid chunks as a random number sequence which can be reusable. In some examples, given that the random bits of the invalid chunks may not be explicitly encrypted during transmission, they have been exposed and may not be trustworthy.

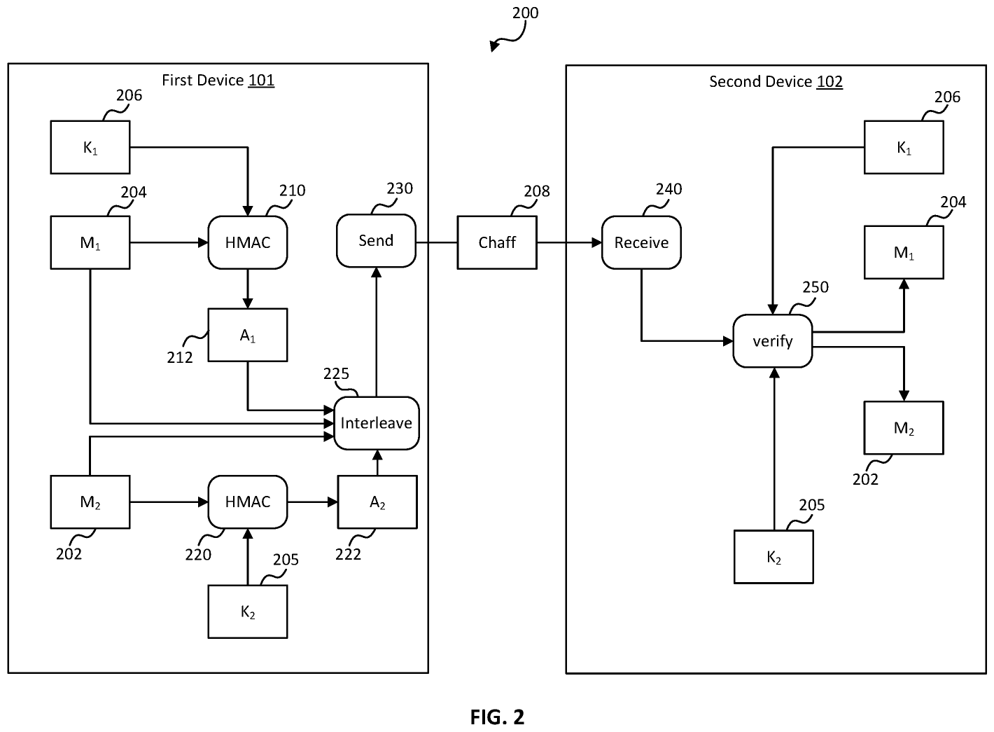

FIG. 2 is a schematic diagram illustrating an example method 200 for performing authentication, according to various arrangements. The method 200 can be performed using the first device 101 and the second device 102. In some arrangements, the secondary authentication provides authentication with a valid chaff that uses QKD to distribute random bits to generate invalid message chunks as a second authentication mechanism. The first device 101 sends a chaff 208 to the second device 102.

In some arrangements, the first device 101 divides (e.g., partitions, dissects, and so on) a first cleartext message 204 (M₁) into the plurality of N portions (m₁₁, m₁₂, . . . , m_{1N}), e.g., M₂=m₁₁, m₁₂, . . . , m_{1N}. The first device 101 generates a message authentication code 212 (e.g., A₁=a₁₁, a₁₂, . . . , a_{1N}) for each of the N portions, also referred to as first authentication codes. For example, the first device 101 can input each portion of the first cleartext message 204 (M₁) and a cryptographic key 206 (K₁) into a cryptographic function such as an HMAC 210 to generate the message authentication code 212 (A₁) for each chunk of the message 204. In some examples, each message authentication code 212 is a check value for a corresponding portion of the message 204. In some examples, the first device 101 and the second device 102 can establish the symmetric cryptographic key 206 (K₁) using any suitable key distribution methods, including QKD as described herein.

In some arrangements, the first cleartext message 204 described herein can be any type of information. Examples of message 204 can include a PIN, a PAN which is the payment card number (e.g., a credit card number, a debit card number, and the like), a financial account number, a password, social security number, a name, an address, an email address, or any PII or PHI. In some examples, the message 204 can be a security object (e.g., a token, a certificate, and the like). In some examples, the message 204 can be a seed for key-generation (e.g., for generating an OTP). The message 204 refers to any information that needs protection during transmission and storage.

The first device 101 can determine first chunks for the message 204, such as the pairs (m₁₁, a₁₁), (m₁₂, a₁₂), . . . (m_{1N}, a_{1N}). That is, each first chunk is a pair including a portion of the cleartext message 204 and a corresponding message authentication code 212 for that portion. In some examples, the first chunks are valid chunks. In some examples, the authentication code 212 for each portion of the message 204 can be concatenated or appended to the portion of the message 204, such that the first chunks can be represented as (m₁₁, a₁₁), (m₁₂, a₁₂), . . . (m_{1N}, a_{1N}). In other examples, each authentication code 212 and a corresponding portion of the message 204 for which the authentication code 212 is generated can be combined in another suitable method.

In some arrangements, the first device 101 divides (e.g., partitions, dissects, and so on) a second cleartext message 202 (M₂) into the plurality of N portions (m₂₁, m₂₂, . . . , m_{2N}), e.g., M₂=m₂₁, m₂₂, . . . , m_{2N}. The first device 101 generates a message authentication code 222 (e.g., A₂=a₂₁, a₂₂, . . . , a_{2N}) for each of the N portions, also referred to as second authentication codes. For example, the first device 101 can input each portion of the second cleartext message 202 (M₂) and a cryptographic key 205 (K₂) into a cryptographic function such as an HMAC 220 to generate the message authentication code 222 (A₂) for each chunk of the message 202. In some examples, each message authentication code 222 is a check value for a corresponding portion of the message 202. In some examples, the first device 101 and the second device 102 can establish the symmetric cryptographic key 205 (K₂) using any suitable key distribution methods, including QKD as described herein.

In some arrangements, the message 202 can be a randomized string of alphanumeric values. The first device 101 does not intend for the second device 102 to use the message 202 for any tasks aside from authentication and verification. That is, the message 202 is used only for chaffing for the message 204.

In some arrangements, the second cleartext message 202 described herein can be any type of information. Examples of message 202 can include a PIN, a PAN which is the payment card number (e.g., a credit card number, a debit card number, and the like), a financial account number, a password, social security number, a name, an address, an email address, or any PII or PHI. In some examples, the message 202 can be a security object (e.g., a token, a certificate, and the like). In some examples, the message 202 can be a seed for key-generation (e.g., for generating an OTP). In such examples, the message 202 can include any information that needs protection during transmission and storage.

The first device 101 can determine second chunks for the message 202, such as the pairs (m₂₁, a₂₁), (m₂₂, a₂₂), . . . (m_{2N}, a_{2N}). That is, each second chunk is a pair including a portion of the cleartext message 202 and a corresponding message authentication code 222 for that portion. The first chunks are valid chunks in the examples in which the message 202 includes information. The second chunks are invalid chunks in the examples in which the message 202 includes random information or values and is intended only for chaffing. In some examples, the authentication code 222 for each portion of the message 202 can be concatenated or appended to the portion of the message 202, such that the second chunks can be represented as (m₂₁, a₂₁), (m₂₂, a₂₂), . . . (m_{2N}, a_{2N}). In other examples, each authentication code 222 and a corresponding portion of the message 202 for which the authentication code 222 is generated can be combined in another suitable method.

The second chunks for the message 202 cannot be verified using the key 206 but can be verified using the key 205. Similarly, the first chunks for the message 204 cannot be verified using the key 205 but can be verified using the key 206. In the examples in which the first chunks are valid and the second chunks are invalid, the second chunks are used only for chaffing. In such examples, the second chunks fail to be verified or authenticated by the second device 102, which uses the key 206 for each chunk. In the examples in which the first chunks and the second chunks are both valid and contain information for two different valid messages 202 and 204, respectively, both the first chunks and the second chunks can be verified, authenticated, and assembled at the second device 102. This allows two different valid messages to be chaffed at the same time, allowing two different valid messages to protect each other. While the arrangements disclosed herein describe two valid messages chaffed, three or more messages can be chaffed in a similar manner.

The first device 101 interleaves the first chunks with the second chunks at 225. In some examples, the first chunks (m₁₁, a₁₁), (m₁₂, a₁₂), . . . (m_{1N}, a_{1N}) and the second chunks (m₂₁, a₂₁), (m₂₂, a₂₂), . . . (m_{2N}, a_{2N}) are interleaved in a random pattern. In some examples, a number (e.g., any number that is 0 or greater than 0) of at least one second chunk and/or which one(s) of the second chunks included between two adjacent first chunks in sequence can be random. In some examples, after being interleaved randomly with the second chunks, the first chunks maintain their respective sequence but with none or at least one second chunk between two adjacent first chunks. In some examples, after being interleaved randomly with the second chunks, the first chunks do not maintain their respective sequence, with none or at least one second chunk between two adjacent first chunks. The resulting data structure with the second chunks interleaved with the first chunks is referred to as the chaff 208. At 230, the first device 101 sends the chaff 208 that includes the first chunks interleaved with the second chunks to the second device 102, which is a receiver.

FIG. 4 is a schematic diagram illustrating an example chaff 400 according to various arrangements. The chaff 400 is an example of the chaff 208. The chaff 400 includes chunks 410. Each chunk 410 of the chaff 400 can be a second chunk (m₂, a₂) or a first chunk (m₁, a₁). In some arrangements, each chunk of the chaff 400 has a data packet size, which is a suitable data size for transmitting a unit of data over a network as a network data packet. That is, the chunks 410 of the chaff 400 have a same size. As shown, the second chunks (m₂₁, a₂₁), (m₂₂, a₂₂), . . . (m_{2N}, a_{2N}) are interleaved with the first chunks (m₁₁, a₁₁), (m₁₂, a₁₂), . . . (m_{1N}, a_{1N}). In some examples, at least one second chunk is immediately between two adjacent first chunks. In some examples, there is no second chunk between two adjacent first chunks. In some examples, at least one first chunk is immediately between two adjacent second chunks. In some examples, there is no first chunk between two adjacent second chunks. While the second chunks are shown to have N elements (e.g., (m₂₁, a₂₁), (m₂₂, a₂₂), . . . (m_{2N}, a_{2N})), given that in some examples, the second chunks and the first chunks are interleaved in a random pattern as shown, there can be any number of second chunks interleaved with the first chunks.

The second device 102 receives the chaff 208 at 240 and verifies each chunk of the chaff 208 at 250. In the examples in which the message 202 is random or invalid, and the second chunks are invalid, verification at 250 includes verifying each chunk of the chaff 208 using the key 206 and the HMAC 210. For example, given that the chaff 208 includes the valid first chunks interleaved with the second invalid chunks, the valid first chunks can be winnowed from the invalid second chunks to reassemble the cleartext message 204. In some examples, to verify each chunk of the chaff 208 at 250, the second device 102 runs a first portion of each chunk (e.g., m₁ or m₂) through a same cryptographic function (e.g., the HMAC 210) with the same cryptographic key 206 (K₁) to generate a possible message authentication code A*, which is compared with a second portion of the chunk (e.g., a₁ or a₂). In response to determining that the possible message authentication code generated by the second device 102 matches the second portion of the chunk (e.g., A*=A₁), then that chunk is verified. On the other hand, in response determining that the possible message authentication code generated by the second device 102 fails to match the second portion of the chunk (e.g., A*≠A₁), then that chunk fails to be verified and is determined to be an invalid second chunk. Given that the authentication code A₂ for the invalid second chunks is calculated using an HMAC function 220 and key 205 different from those (e.g., the HMAC 210 and the key 206) used for the valid first chunks, the second portion (e.g., A₂) of an invalid second chunk would not match the result of running the first portion of the invalid second chunk through the HMAC 210 using the key 206, which are used for the valid first chunks. The second device 102 reassembles the first portions of the the valid first chunks to recover the original cleartext message 204 (M).

In the examples in which the message 202 is a valid message different from the valid message 204, and the second chunks are valid, verification at 250 includes verifying each chunk of the chaff 208 using the key 206 and the HMAC 210 as well as using the key 205 and the HMAC 220. For example, given that the chaff 208 includes the valid first chunks interleaved with the valid second chunks, the valid first chunks can be winnowed from the valid second chunks to reassemble the cleartext message 204, and the valid second chunks can likewise be winnowed from the valid first chunks to reassemble the cleartext message 202. This allows both messages 202 and 204 to be reassembled.

In some examples, to verify each chunk of the chaff 208 at 250, the second device 102 runs a first portion of each chunk (e.g., m₁ or m₂) through a first cryptographic function (e.g., the HMAC 210) with a first cryptographic key 206 (K₁) to generate a possible message authentication code A*, which is compared with a second portion of the chunk (e.g., a₁ or a₂). In response to determining that the possible message authentication code generated by the second device 102 matches the second portion of the chunk (e.g., A*=A₁), then that chunk is determined to be part of the first message (corresponding to the HMAC 210 and the key 206 used) and is verified. On the other hand, in response determining that the possible message authentication code generated by the second device 102 fails to match the second portion of the chunk (e.g., A*≠A₁), the second device 102 runs the same first portion of that chunk (e.g., m₁ or m₂) through a second cryptographic function (e.g., the HMAC 220) with a second cryptographic key 205 (K₂) to generate another possible message authentication code A*, which is compared with a second portion of the chunk (e.g., a₁ or a₂). In response to determining that the possible message authentication code generated by the second device 102 matches the second portion of the chunk (e.g., A*=A₂), then that chunk is determined to be part of the second message (corresponding to the HMAC 220 and the key 205 used) and is verified. The second device 102 reassembles the first portions of the first chunks identified to be part of the first message to recover the original first cleartext message 204 (M₁). The second device 102 reassembles the first portions of the second chunks identified to be part of the second message to recover the original second cleartext message 202 (M₂).

In some examples, the first device 101 and the second device 102 can establish one or more of the symmetric cryptographic keys 205 or 206 using any suitable key distribution methods, including QKD. For example, the first device 101 has a Quantum Device (QD), and the second device 102 has a QD. A QKD device can perform QKD with the QDs of the first and second devices 101 and 102. For example, the first device 101 uses its QD to measure the QKD transmission of photons (e.g., entangled or regular, unentangled particles) from the QKD device to generate one or more of the cryptographic keys 205 or 206. In some examples, the QD of the first device 101 can be a Quantum Entangled Device (QED) that measures transmissions (e.g., quantum entangled particles or photons) received from the QKD device. In some examples, the QD of the first device 101 can be a device configured to measure regular, non-entangled quantum particles or phones received from the QKD device.

The second device 102 uses its QD to measure the QKD transmission of photons (e.g., entangled or regular, unentangled particles) from the QKD device to generate one or more of the cryptographic keys 205 or 206. In some examples, the QD of the second device 102 can be a QED that measures transmissions (e.g., quantum entangled particles or photons) received from the QKD device. In some examples, the QD of the second device 102 can be a device configured to measure regular, non-entangled quantum particles or phones received from the QKD device. The QDs of the first and second devices 101 and 102 are the same type of quantum devices. The cryptographic key 106 can be established by the first and second devices 101 and 102 similarly. In some examples, the first device 101 and the second device 102 can establish one or more of the cryptographic keys 106, 205, or 206 using any other suitable key distribution methods

Given that the QKD transmission is random, the message cannot be replayed, and different keys 205 and 206 are used to verify the authentication codes, the first and second authentication codes cannot be counterfeited.

FIG. 5 is a schematic block diagram illustrating a QKD method 500, according to some arrangements. QKD is mechanism by which keys (e.g., one or more of the cryptographic keys 106, 205, or 206) are established between two communicating parties, such as the devices 101 and 102. Example QKD protocols include the BB84 protocol and the E91 protocol. A QKD device 502 generates two steams of quantum particles 510a and 510b (e.g., photons containing information such as a string of binary zeroes and ones) and sends one stream to QD 512 of the first device 101 and another to QD 514 of the second device 102. The quantum particles 510a and 510b can be quantum entangled particles or regular non-entangled particles. In some examples, each stream of the quantum particles 510a and 510b includes random bits.

In some examples, one of the participants (e.g., the devices 101 and 102) manages the QKD device 502. In some examples, a third party other than the participants manages the QKD device 502. The QDs 512 and 514 both read the quantum particles 510a and 510b, interpreting the same string of binary zeroes and ones and converting the same into a cryptographic key (e.g., one or more of the cryptographic keys 106, 205, or 206) using a Key Derivation Function (KDF). The devices 101 and 102can use a separate communication channel to statically verify that the devices 101 and 102 have read and interpreted the particles correctly, e.g., one or more of the cryptographic keys 106, 205, or 206read by the devices 101 and 102 are the same.

In the examples in which the quantum particles 510a and 510b are entangled, one device reading the entangled quantum particles 510a or 510b before another device destroys the entanglement given that although the another device reads the same information, the entangled particles are affected by the prior reading of the entangled particles. Thus, if another attempt is made by one of the devices 101 and 102 or an attacker to re-read the same stream, the affected particles become no longer entangled, resulting in a different interpretation. Further, an attacker reading a stream before the devices 101 and 102 breaks the entanglement such that when the devices 101 and 102 reads the stream, the reading affects the particles, and the devices 101 and 102 will obtain an invalid interpretation. An attacker reading the stream after the devices 101 and 102 read the stream also affects the detangled particles, and devices 101 and 102 will obtain an invalid interpretation. QKD allows an attacker to be detected such that the device 110 and the QDs 512 and 514 have knowledge of the attack by detecting invalid interpretation, thus refraining from using the stream to establish a cryptographic key.

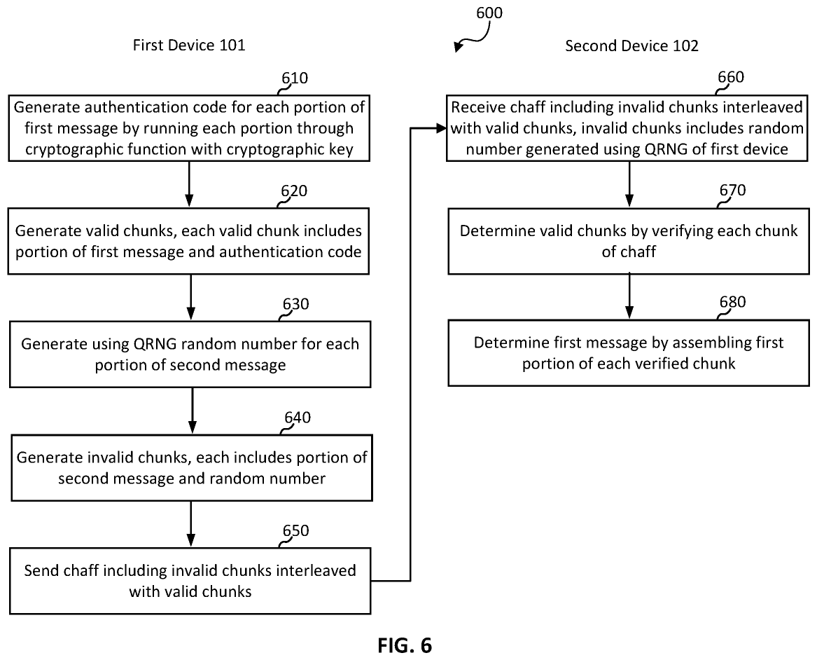

FIG. 6 is a flowchart diagram illustrating an example method 600 for performing primary authentication, according to various arrangements. The method 100 is an example implementation of the method 600. The method 600 can be performed by the first device 101 and the second device 102.

At 610, the first device 101 generates an authentication code (e.g., the message authentication code 104) for each of a plurality of portions of the first message (e.g., the message 104) by running each of the plurality of portions of the first message through a cryptographic function (e.g., the HMAC 120) with a cryptographic key (e.g., the key 106). At 620, the first device 101 generates a plurality of valid chunks. Each of the plurality of valid chunks includes one of the plurality of portions of the first message and the corresponding authentication code generated for that portion. At 630, the first device 101 generates using a QRNG (e.g., the QRNG 110), a random number for each of the plurality of portions of a second message (e.g., the message 103). At 640, the first device 101 generates a plurality of invalid chunks. Each of the plurality of invalid chunks includes one of the plurality of portions of the second message and a random number generated by the QRNG. At 650, the first device 101 sends to the second device 102 chaff (e.g., the chaff 108 or 300) including the plurality of invalid chunks interleaved with the plurality of valid chunks.

At 660, the second device 102 receives from the first device 101 the chaff that includes the plurality of chunks. The plurality of chunks includes plurality of invalid chunks interleaved with a plurality of valid chunks. Each of the plurality of invalid chunks includes a random number generated using a QRNG 110 of the first device 101.

At 670, the second device 102 determines the plurality of valid chunks by verifying each of the plurality of chunks of the chaff. Verifying each of the plurality of chunks of the chaff includes determining a possible authentication code (e.g., the authentication code 123) by running a first portion of a chunk of the plurality of chunks of the chaff through a cryptographic function (e.g., the HMAC 120) with a cryptographic key (e.g., the key 106) The second device 102 verifies each chunk of the plurality of chunks of the chaff in response to determining that the possible authentication code matches or is the same as a second portion of that chunk. At 680 the second device 102 determines the first message by assembling the first portions of each verified chunk of the plurality of chunks.

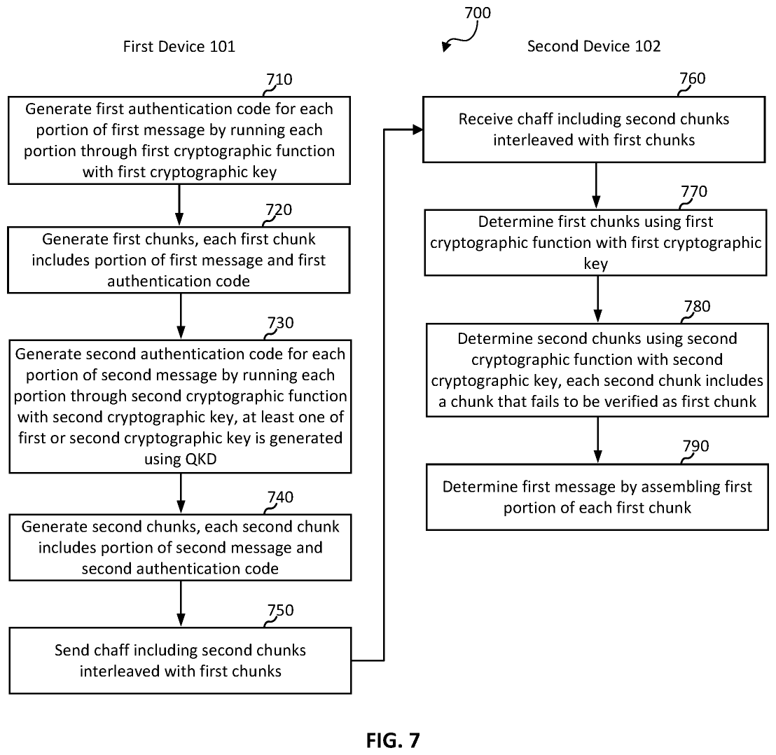

FIG. 7 is a flowchart diagram illustrating an example method 700 for performing secondary authentication, according to various arrangements. The method 200 is an example implementation of the method 700. The method 700 can be performed by the first device 101 and the second device 102.

At 710, the first device 101 generates a first authentication code (e.g., message authentication code 212) for each of a plurality of portions of a first message (e.g., the message 204) by running each of the plurality of portions of the first message through a first cryptographic function (e.g., the HMAC 210) with a first cryptographic key (e.g., the key 206). At 720, the first device 101 generates a plurality of first chunks. Each of the plurality of first chunks includes one of the plurality of portions of the first message and the corresponding first authentication code.

At 730, the first device 101 generates a second authentication code (e.g., message authentication code 222) for each of a plurality of portions of a second message (e.g., the message 202) by running each of the plurality of portions of the second message through a second cryptographic function (e.g., the HMAC 220) with a second cryptographic key (e.g., the key 205). At least one of the first cryptographic key or the second cryptographic key is generated using QKD. At 740, the first device 101 generates a plurality of second chunks. Each of the plurality of second chunks includes one of the plurality of second portions and the corresponding second authentication code. At 750, the first device 101 sends to the second device 102 the chaff (e.g., the chaff 208 or 400) including the plurality of second chunks interleaved with the plurality of first chunks.

At 760, the second device 102 receives from the first device 101 the chaff including a plurality of chunks. The plurality of chunks includes plurality of second chunks interleaved with a plurality of first chunks.

At 770, the second device 102 determines the plurality of first chunks by determining a possible first authentication code by running a first portion of a chunk of the plurality of chunks of the chaff through a first cryptographic function with a first cryptographic key. Determining the plurality of first chunks of the chaff further includes verifying the chunk of the plurality of chunks of the chaff in response to determining that the possible first authentication code matches a second portion of the chunk of the plurality of chunks. The verified chunk is a first chunk of the first message.

At 780, the second device 102 determines the plurality of second chunks using a second cryptographic function and a second cryptographic key. Each of the plurality of second chunks includes a chunk of the plurality of chunks of the chaff that fails to be verified using the possible first authentication code. At 790, the second device 102 determines the first message by assembling the first portions of the plurality of determined chunks. In the examples that the second message is a valid message, the second device 102 determines the second message by assembling the first portions of the plurality of determined second chunks.

In some arrangements, determining the plurality of second chunks by the second device 102 includes determining a possible second authentication code by running a first portion of a chunk that fails to be verified using the possible first authentication code through the second cryptographic function with the second cryptographic key and verifying that chunk in response to determining that the possible second authentication code matches a second portion of that chunk.

In some arrangements, the second portion of each of the plurality of first chunks includes a first authentication code generated by the first device using the first cryptographic function and the first cryptographic key. In some arrangements, the second portion of each of the plurality of second chunks includes a second authentication code generated by the first device using the second cryptographic function and the second cryptographic key.

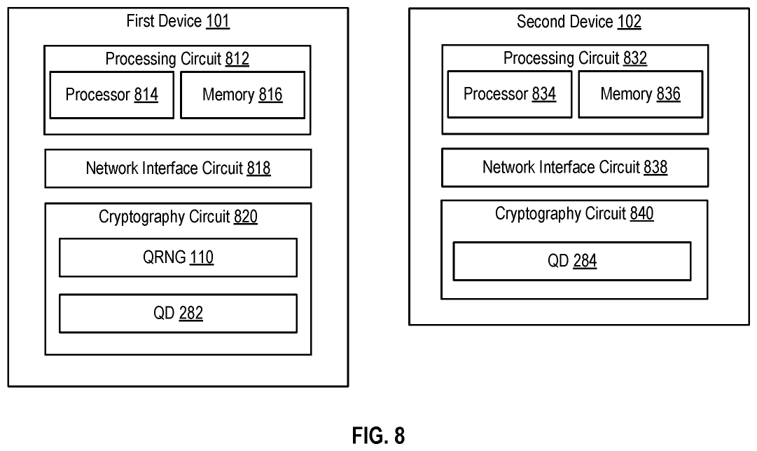

FIG. 8 illustrates block diagrams of an examples of the first device 101 and the second device 102, according to some arrangements. The devices 101 and 102 are shown to include various circuits and logic for implementing the operations described herein. More particularly, the device 110 includes one or more of a processing circuit 812, a network interface circuit 818, and a cryptography circuit 820. The second device 102 includes one or more of a processing circuit 832, a network interface circuit 838, and a cryptography circuit 840. While various circuits, interfaces, and logic with particular functionality are shown, it should be understood that the devices 101 and 102 can include any number of circuits, interfaces, and logic for facilitating the operations described herein. For example, the activities of multiple circuits are combined as a single circuit and implemented on a same processing circuit (e.g., the processing circuit 812 and 832), as additional circuits with additional functionality are included.

In some arrangements, the processing circuit 812 includes a processor 814 and a memory 816. The processor 814 is implemented as a general-purpose processor, an Application Specific Integrated Circuit (ASIC), one or more Field Programmable Gate Arrays (FPGAs), a Digital Signal Processor (DSP), a group of processing components, or other suitable electronic processing components. The memory 816 (e.g., Random Access Memory (RAM), Read-Only Memory (ROM), Non-Volatile RAM (NVRAM), Flash Memory, hard disk storage, etc.) stores data and/or computer code for facilitating the various processes described herein. Moreover, the memory 816 is or includes tangible, non-transient volatile memory or non-volatile memory. Accordingly, the memory 816 includes database components, object code components, script components, or any other type of information structure for supporting the various activities and information structures described herein. The processing circuit 812 can be used to implemented one or more of the circuits 818 and 820.

The network interface circuit 818 is configured for and structured to establish a connection and communicate with second device 102 via a network or another suitable wired, wireless, or physical connection. The network interface circuit 818 is structured for sending and receiving data over a communication network or a physical connection (e.g., via a physical connector such as Universal Serial Bus (USB)). Accordingly, the network interface circuit 818 includes any of a cellular transceiver (for cellular standards), wireless network transceiver (for 802.11X, ZigBee, Bluetooth, Wi-Fi, or the like), wired network interface, or a combination thereof. For example, the network interface circuit 818 may include wireless or wired network modems, ports, baseband processors, and associated software and firmware.

The network can be any suitable Local Area Network (LAN), Wide Area Network (WAN), or a combination thereof. For example, the network can be supported by Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS) Wideband Code Division Multiple Access (WCDMA), Long Term Evolution (LTE), evolved Multimedia Broadcast Multicast Services (eMBMS), High-Speed Downlink Packet Access (HSDPA), and the like), Universal Terrestrial Radio Access (UTRA), Global System for Mobile Communications (GSM), Code Division Multiple Access 1× Radio Transmission Technology (1×), General Packet Radio Service (GPRS), Personal Communications Service (PCS), 802.11X, ZigBee, Bluetooth, Wi-Fi, any suitable wired network, combination thereof, and/or the like. The network is structured to permit the exchange of data, values, instructions, messages, and the like.

The cryptography circuit 820 is executed by the processing circuit 812 in some arrangements. The cryptography circuit 820 can perform cryptographic operations (e.g., the methods performed by the first device 101 described herein) such as the cryptographic functions (e.g., the HMAC 120, 210, and 220) in the manner described. The device 110 can provide the cryptography circuit 820 in various manners. In some arrangements, the cryptography circuit 820 is a server-based application executable on the device 110. In this regard, the user of the device 110 has to download the cryptography circuit 820 from an application download server prior to usage. In some arrangements, the cryptography circuit 820 is a web-based interface application provided by an application server. In some arrangements, the cryptography circuit 820 includes an API and/or an SDK provided by the application server that facilitates integration with other applications. In some arrangements, the cryptography circuit 820 is coded into the memory 816 of the device 110. All such variations and combinations are intended to fall within the spirit and scope of the present disclosure.

The cryptography circuit 820 includes a QRNG 110. The QRNG 110 can generate a stream of quantum particles (entangled or regular), such as photons containing information such as a string of binary zeroes and ones. The stream of quantum entangled particles correspond to the random number of the invalid chunks 105. The cryptography circuit 820 further includes the QD 512.

In some arrangements, the processing circuit 832 has a processor 834 and memory 836. The processor 834 is a processing component such as the processor 814. The memory 836 is a memory device such as the memory 816. The processing circuit 832 can be used to implemented one or more of the circuits 838 and 840.

The network interface circuit 838 is a network device such as the network interface circuit 818. The network interface circuit 838 is configured for and structured to establish a connection and communicate with the device 110 via the network or another suitable wired, wireless, or physical connection.

The cryptography circuit 840 can be implemented with the processing circuit 832 or a separate processing circuit similar to the processing circuit 832. In some arrangements, the cryptography circuit 840 can perform cryptographic operations (e.g., the methods performed by the first device 101 described herein) such as the cryptographic functions (e.g., the operations such as HMAC for the verification at 120, 150, 250) in the manner described. Illustrating with a non-limiting example, the cryptography circuit 840 provides a host-based application to be downloaded by the second device 102. For example, the cryptography circuit 840 provides a web-based application to be accessed by the second device 102 or coded into the memory 836 of the second device 102. The cryptography circuit 840 includes an API and/or an SDK facilitates integration with other applications. All such variations and combinations are intended to fall within the spirit and scope of the present disclosure. The cryptography circuit 840 includes the QD 514.

As utilized herein, the terms “approximately,” “substantially,” and similar terms are intended to have a broad meaning in harmony with the common and accepted usage by those of ordinary skill in the art to which the subject matter of this disclosure pertains. It should be understood by those of ordinary skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

Although only a few arrangements have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter described herein. For example, elements shown as integrally formed may be constructed of multiple components or elements, the position of elements may be reversed or otherwise varied, and the nature or number of discrete elements or positions may be altered or varied. The order or sequence of any method processes may be varied or re-sequenced according to alternative arrangements. Other substitutions, modifications, changes, and omissions may also be made in the design, operating conditions and arrangement of the various exemplary arrangements without departing from the scope of the present disclosure.

The arrangements described herein have been described with reference to drawings. The drawings illustrate certain details of specific arrangements that implement the systems, methods and programs described herein. However, describing the arrangements with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some arrangements, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some arrangements, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some arrangements, the one or more processors may be embodied in various ways. The one or more processors may be constructed in a manner sufficient to perform at least the operations described herein. In some arrangements, the one or more processors may be shared by multiple circuits (e.g., circuit A and circuit B may include or otherwise share the same processor which, in some example arrangements, may execute instructions stored, or otherwise accessed, via different areas of memory). Alternatively or additionally, the one or more processors may be structured to perform or otherwise execute certain operations independent of one or more co-processors. In other example arrangements, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some arrangements, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the arrangements might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), a distributed ledger (e.g., a blockchain), etc. In some arrangements, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other arrangements, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example arrangements described herein.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative arrangements. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web arrangements of the present disclosure could be accomplished with standard programming techniques with rule based logic and other logic to accomplish the various database searching steps, correlation steps, comparison steps and decision steps.

The foregoing description of arrangements has been presented for purposes of illustration and description. It is not intended to be exhaustive or to limit the disclosure to the precise form disclosed, and modifications and variations are possible in light of the above teachings or may be acquired from this disclosure. The arrangements were chosen and described in order to explain the principals of the disclosure and its practical application to enable one skilled in the art to utilize the various arrangements and with various modifications as are suited to the particular use contemplated. Other substitutions, modifications, changes and omissions may be made in the design, operating conditions and arrangement of the arrangements without departing from the scope of the present disclosure as expressed in the appended claims.

What is claimed is:

1. A method, comprising:
generating, by a first device, a first authentication code for each of a plurality of portions of a first message by running each of the plurality of portions of the first message through a first cryptographic function with a first cryptographic key;
generating, by the first device, a plurality of first chunks, each of the plurality of first chunks comprising one of the plurality of portions of the first message and the corresponding first authentication code;
generating, by the first device, a second authentication code for each of a plurality of portions of a second message by running each of the plurality of portions of the second message through a second cryptographic function with a second cryptographic key, wherein at least one of the first cryptographic key or the second cryptographic key is generated using Quantum Key Distribution (QKD);
generating, by the first device, a plurality of second chunks, each of the plurality of second chunks comprising one of the plurality of portions of the second message and the corresponding second authentication code;
sending, by the first device to the second device, chaff comprising the plurality of second chunks interleaved with the plurality of first chunks.

2. The method of claim 1, wherein
the first cryptographic function comprises a first Hash-based Message Authentication Code (HMAC);
the second cryptographic function comprises a second HMAC; and
the first HMAC is different from the second HMAC.

3. The method of claim 1, wherein
the first authentication code comprises a first check value; and
the second authentication code comprises at least one second check value.

4. The method of claim 1, wherein the plurality of second chunks are randomly interleaved with the plurality of first chunks.

5. The method of claim 1, further comprising determining the at least one of the first cryptographic key or the second cryptographic key by measuring, by a Quantum Device (QD) of the first device, transmission from a QKD device.

6. The method of claim 1, wherein each of the plurality of first chunks comprises the corresponding first authentication code appended or concatenated to the one of the plurality of portions of the first message.

7. The method of claim 6, wherein each of the plurality of second chunks comprises the corresponding second authentication code appended or concatenated to the one of the plurality of portions of the second message.

8. The method of claim 1, wherein the second device determines the plurality of first chunks by verifying each of a plurality of chunks of the chaff, wherein verifying each of the plurality of chunks of the chaff comprises:
determining a possible first authentication code by running a first portion of a chunk of the plurality of chunks of the chaff through the first cryptographic function with the first cryptographic key; and
verifying the chunk of the plurality of chunks of the chaff in response to determining that the possible first authentication code matches a second portion of the chunk of the plurality of chunks.

9. The method of claim 1, wherein the second device determines the plurality of second chunks by:
determining a possible second authentication code by running a first portion of a chunk of the plurality of chunks of the chaff through the second cryptographic function with the second cryptographic key; and
determining the chunk as one of the plurality of second chunks in response to determining that the possible second authentication code matches a second portion of the chunk of the plurality of chunks, wherein the plurality of second chunks comprises chunks of the plurality of chunks of the chaff that fail to be verified using a possible first authentication code.

10. A method, comprising:
receiving, by a second device from a first device, chaff comprising a plurality of chunks, the plurality of chunks comprising a plurality of second chunks interleaved with a plurality of first chunks;
determining, by the second device, the plurality of first chunks by:
determining a possible first authentication code by running a first portion of a chunk of the plurality of chunks of the chaff through a first cryptographic function with a first cryptographic key;
verifying the chunk of the plurality of chunks of the chaff in response to determining that the possible first authentication code matches a second portion of the chunk of the plurality of chunks, wherein the verified chunk is one of the plurality of first chunks; and
determining, by the second device, the plurality of second chunks using a second cryptographic function and a second cryptographic key, wherein each of the plurality of second chunks comprises a chunk of the plurality of chunks that fails to be verified using the possible first authentication code, wherein at least one of the first cryptographic key or the second cryptographic key is generated using Quantum Key Distribution (QKD); and
determining, by the second device, a first message by assembling the first portions of the plurality of determined first chunks.

11. The method of claim 10, wherein determining the plurality of second chunks comprises:
determining a possible second authentication code by running a first portion of the chunk that fails to be verified using the possible first authentication code through the second cryptographic function with the second cryptographic key; and
verifying the chunk in response to determining that the possible second authentication code matches a second portion of the chunk.

12. The method of claim 11, wherein second portion of each of the plurality of second chunks comprises a second authentication code generated by the first device using the second cryptographic function and the second cryptographic key.

13. The method of claim 11, further comprising determining, by the second device, a second message by assembling the first portions of the plurality of determined second chunks.

14. The method of claim 10, wherein second portion of each of the plurality of first chunks comprises a first authentication code generated by the first device using the first cryptographic function and the first cryptographic key.

15. The method of claim 10, wherein each of the plurality of second chunks are invalid chunks.

16. The method of claim 10, wherein
the first cryptographic function comprises a first Hash-based Message Authentication Code (HMAC);
the second cryptographic function comprises a second HMAC; and
the first HMAC is different from the second HMAC.

17. A method, comprising:
generating, by a first device, an authentication code for each of a plurality of portions of a first message by running each of the plurality of portions of the first message through a cryptographic function with a cryptographic key;
generating, by the first device, a plurality of valid chunks, each of the plurality of valid chunks comprising one of the plurality of portions of the first message and the corresponding authentication code;
generating, by the first device using a Quantum Random Number Generator (QRNG), a random number for each of a plurality of portions of a second message;
generating, by the first device, a plurality of invalid chunks, wherein each of the plurality of invalid chunks comprises one of the plurality of portions of the second message and the corresponding random number; and
sending, by the first device to the second device, chaff comprising the plurality of invalid chunks interleaved with the plurality of valid chunks.

18. The method of claim 17, wherein the cryptographic function comprises a Hash-based Message Authentication Code (HMAC).

19. The method of claim 17, wherein the second device determines the plurality of valid chunks by verifying each of the plurality of chunks of the chaff, wherein verifying each of the plurality of chunks of the chaff comprises:
determining a possible authentication code by running a first portion of a chunk of the plurality of chunks of the chaff through the cryptographic function with the cryptographic key; and
verifying the chunk of the plurality of chunks of the chaff in response to determining that the possible authentication code matches a second portion of the chunk of the plurality of chunks.

20. The method of claim 19, wherein the second device determines the first message by assembling the first portions of the plurality of valid chunks.

21. A method, comprising:
receiving, by a second device from a first device, chaff comprising a plurality of chunks, the plurality of chunks comprising a plurality of invalid chunks interleaved with a plurality of valid chunks, wherein each of the plurality of invalid chunks comprises a random number generated using a Quantum Random Number Generator (QRNG) of the first device; and
determining, by the second device, the plurality of valid chunks by verifying each of the plurality of chunks of the chaff, wherein verifying each of the plurality of chunks of the chaff comprises:
determining a possible authentication code by running a first portion of a chunk of the plurality of chunks of the chaff through a cryptographic function with a cryptographic key;
verifying the chunk of the plurality of chunks of the chaff in response to determining that the possible authentication code matches a second portion of the chunk of the plurality of chunks; and
determining, by the second device, a first message by assembling the first portions of each verified chunk of the plurality of chunks.
